(19) United States
(12) Patent Application Publication
(10) Pub. No.: US 2002/0174186 A1
(43) Pub. Date: Nov. 21, 2002

(54) Electronic mail typestyle processing device

(76) Inventors: Koichi Hashimoto, Ibaraki-ken (JP); Yasuhiro Yamazaki, Ibaraki-ken (JP); Xuqiang Bai, Ibaraki-ken (JP)

Correspondence Address: NATH & ASSOCIATES, 1030 15th STREET, 6TH FLOOR, WASHINGTON, DC, 20005, US

(21) Appl. No.: 10/142,940

(22) Filed: May 13, 2002

(30) Foreign Application Priority Data
May 15, 2001 (JP) P2001-145395

(51) Int. Cl. G06F 15/16

(52) U.S. Cl. 709/206

(57) ABSTRACT

A user typestyle font reflecting personality of a registered user is stored in a font data memory in advance. When an electronic mail from the registered user is received, an authorizer performs authorization processing and then a typestyle of text of the electronic mail is processed by a text typestyle processor by use of the user typestyle font. The electronic mail is transmitted to a receiver of the electronic mail thereafter.

### BACKGROUND OF THE INVENTION

1. Field of the Invention

The present invention relates to an electronic mail typestyle processing device which processes text data of an electronic mail with a typestyle reflecting personality of a sender of the electronic mail so that a receiver side of the electronic mail can browse the electronic mail in such a typestyle.

2. Description of the Related Art

Along with widespread use of interactive electronic networks as typified by the Internet, electronic mails are gaining popularity as means for communication among individuals. Heretofore, workstations and personal computers have been mainly used as means for transmitting and receiving electronic mails. However, in recent years, an electronic mail transmission/receipt program called a mailer is also loaded on a variety of hardware such as portable information processing terminals called personal data assistants (PDAs), mobile phones, domestic fixed telephone sets, home game machines and television sets, whereby these apparatuses can be used as transmission/receipt terminals for electronic mails.

Text information transmitted as an electronic mail is normally reproduced by character codes of characters constituting the text. And by displaying character images corresponding to the character codes on a receiving terminal, the receiver can read the text of the electronic mail. For this reason, a font set reproduced by combinations of character codes and character image data corresponding to the character codes is loaded on terminals for transmission/receipt of electronic mails.

Incidentally, the mailer on the receiving terminal normally uses one font type for displaying electronic mail text. Therefore, the reality is that a typestyle of electronic mail text displayed on the receiving terminal is monotonous.

There might not be particular complaints about the monotonous typestyle of text if contents of electronic mail text are concerning business matters or formal issues. Nevertheless, there are many people who wish to send electronic mails reflecting their personalities when they send messages or the like to close people, for example. Currently, those people send electronic mails with various ingenuities such as putting their nicknames into sender's names or giving witty designs to their signatures by a combination of special characters. However, if a typestyle of electronic mail text can reflect a sender's personality like a handwriting letter, it is possible to send a more satisfying electronic mail.

Meanwhile, for a receiver of such an electronic mail, it is convenient if the sender of the electronic mail can be identified when the receiver casts a glance on the typestyle of the electronic mail text like receipt of a handwriting letter.

In response to the foregoing needs, Japanese Unexamined Patent Publication No. 2000-330545 discloses a font service system effectuating creation of a greeting card document of an electronic mail style with a personal font for reflecting a sender's personality.

The font service system disclosed in Japanese Unexamined Patent Publication No. 2000-330545 has a constitution including a client terminal, a personal font server for performing personal font services, a mail server for transmitting mails and a greeting server for performing greeting card services, those being interconnected via a network. Further, the personal font server includes personality parameter extraction service means for performing services by reading hand-written characters from the client server and by extracting personality parameters of the hand-written characters, personal font generation program service means for serving a program for generating a personal font out of a standard typestyle owned by the system as a standard as well as a personality parameter dictionary extracted by the personality parameter extraction service means, and network management means for managing the above-described services on a network on demands by a client. The greeting server inputs a printing document, a personal ID and a mail address from the client terminal, and receives service of the personality parameter dictionary and the personal font generating program from the personal font server. Further, upon receipt of a transmit request from the client, the greeting server converts a greeting card document with the personal font generating program and transmit the document to the mail server.

According to the above-described font service system, a user can send a greeting card to a receiver with a typestyle reflecting his personality.

However, the font service system disclosed in Japanese Unexamined Patent Publication No. 2000-330545 is not designed to enable a client terminal without a special function on the receiver side of an electronic mail to display the standard style electronic mail created by a client terminal on the side of the sender of the electronic mail in the typestyle reflecting the personality of the sender without requirement of a special operation on the sender side. Specifically, in this font service system, it is necessary to describe an instruction of a character typestyle in a document created by the client terminal on the side of the sender of the electronic mail so as to call for the personal font. Moreover, the client terminal on the side of the mail receiver needs to have a function inside to develop the personal font.

Accordingly, the font service system has problems of requiring a complex operation for sending an electronic mail with the typestyle reflecting the personality of the sender, and of requiring preparation of a special terminal for receiving such an electronic mail which is costly.

### SUMMARY OF THE INVENTION

An object of the present invention is to provide an electronic mail typestyle processing device for achieving transmission and receipt of electronic mails in a font reflecting personality of a sender between electronic mail transmission/receipt terminals generally used without requiring a special operation at the sender side.

A first aspect of the present invention is an electronic mail typestyle processing device mutually connected with an electronic mail transmission terminal and an electronic mail receiving terminal via information transmission means, which includes a registered user identifier storing section for storing an identifier of a user registered in advance, a user typestyle font storing section for storing a user typestyle font for each registered user, the user typestyle font reflecting personality of the registered user, a receiving section for receiving an electronic mail transmitted from the electronic mail transmission terminal, an authorizing section for referring to the registered user identifier storing section to judge as to whether data constituting the electronic mail received by the receiving section contains the identifier of the registered user, and a typestyle processing section for creating character image data by processing a typestyle of text of the electronic mail, which is judged by the authorizing section as containing the identifier of the registered user, by use of the user typestyle font stored in the user typestyle font storing section.

Moreover, a second aspect of the present invention is the electronic mail typestyle processing device, in which the registered user identifier storing section stores an electronic mail address of the registered user as the identifier of the registered user.

Moreover, a third aspect of the present invention is the electronic mail typestyle processing device further including a data replacing section for replacing the data constituting the text of the electronic mail, which is judged by the authorizing section as containing the identifier of the registered user, with the character image data created by the typestyle processing section, and a transmitting section for transmitting the electronic mail, of which the data constituting the text are replaced with the character image data by the data replacing section, to the electronic mail receiving terminal.

Moreover, a fourth aspect of the present invention is the electronic mail typestyle processing device further including a character image data disclosing section for disclosing the character image data created by the typestyle processing section as a Web page, an access information data replacing section for replacing the data constituting the text of the electronic mail, which is judged by the authorizing section as containing the identifier of the registered user, with access information for having access to the Web page, and a transmitting section for transmitting the electronic mail, of which the data constituting the text are replaced with the access information by the access information data replacing section, to the electronic mail receiving terminal.

Moreover, a fifth aspect of the present invention is the electronic mail typestyle processing device further including a correspondence table storing section for storing an destination-based process propriety correspondence table in which an electronic mail address of each destination is recorded severally for the registered user in association with a specifier specifying as to whether the typestyle of the text of the electronic mail to be transmitted to each destination is processed or not, and a process propriety discriminating section for referring to the destination-based process propriety correspondence table stored in the correspondence table storing section to judge for each destination as to whether the typestyle of the text of the electronic mail judged by the authorizing section as containing the identifier of the registered user is processed or not.

Moreover, a sixth aspect of the present invention is the electronic mail typestyle processing device, in which an address inside the electronic mail typestyle processing device is allocated severally to the registered user, the receiving section is designed to receive an electronic mail transmitted to the address allocated severally to the registered user, and the electronic mail typestyle processing device further includes an address extracting section for extracting an electronic mail address which is an actual destination out of the data constituting the electronic mail received by the receiving section, and an address rewriting section for rewriting a destination address of the electronic mail received by the receiving section into the electronic mail address which is the actual destination.

In the electronic mail typestyle processing device of the present invention, an electronic mail transmitted from the electronic mail transmission terminal via the information transmission means is received by the receiving section. Then, an authorization process of the received electronic mail is performed by the authorizing section. This authorization process is performed by judging whether or not the data constituting the received electronic mail contains the identifier of the user registered in advance (the registered user). To be more precise, the electronic mail address of the registered user, for example, is used as the identifier of the registered user, and this identifier of the registered user is stored in the registered user identifier storing section.

When the authorizing section judges that the data constituting the received electronic mail contains the identifier of the registered user, the typestyle of the text of the electronic mail is processed by the typestyle processing section using the user typestyle font, whereby the character image data are created. The user typestyle font is a font reflecting personality of the registered user, with which character code data is replaced with character image data in accordance with handwriting of the registered user, for example. This user typestyle font is stored in the user typestyle font storing section in advance for each registered user.

The character image data created by the typestyle processing section are converted from the data constituting the text of the electronic mail which is judged as containing the identifier of the registered user by the data replacing section, for example. Specifically, by a conversion process performed by the data replacing section, the text of the electronic mail which is judged as containing the identifier of the registered user is reproduced by character images in the user typestyle font reflecting the personality of the registered user.

Thereafter, the electronic mail in which the data constituting the text are replaced with the character image data is transmitted by the transmitting section to the electronic mail receiving terminal via the information transmission means.

Moreover, in the electronic mail typestyle processing device of the present invention, the character image data created by the typestyle processing section may be disclosed as a Web page by the character image data disclosing section.

In this case, the access information data replacing section replaces the data constituting the text of the electronic mail which is judged as containing the identifier of the registered user into access information for having access to the Web page; specifically, with a uniform resource locator (a URL) of the Web page, for example. Then, the transmitting section transmits the electronic mail, of which the data constituting the text are replaced with the access information for having access to the Web page, to the electronic mail receiving terminal via the information transmission means. At the electronic mail receiving terminal, it is possible to browse the character image data by having access to the Web page using the access information.

Moreover, in the electronic mail typestyle processing device of the present invention, judgment as to whether or not the typestyle of the text of the electronic mail is processed may be performed depending on each destination of the electronic mail.

In this case, the destination-based process propriety correspondence table is stored in the correspondence table storing section in advance. The destination-based process propriety correspondence table is a record in which the electronic mail address of each destination is stored in association with the specifier specifying as to whether or not the typestyle of the text of the electronic mail to be transmitted to each destination is processed. Moreover, this destination-based process propriety correspondence table is referred by the process propriety discriminator, whereby judgment as to whether or not the typestyle of the text of the electronic mail which is judged by the authorizing section as containing the identifier of the registered user is processed is judged for each destination.

Moreover, in the electronic mail typestyle processing device of the present invention, an address inside the electronic mail typestyle processing device may be allocated to each registered user, and the receiving section may be arranged to receive the electronic mail transmitted to the address allocated severally to the registered user.

In this case, actual destination of the electronic mail, that is, the electronic mail address of the electronic mail receiving terminal is written in a specified position of the data constituting the electronic mail received by the receiving section.

Thereafter, the electronic mail address which is the actual destination is extracted by the address extracting section out of the data of the electronic mail received by the receiving section, that is, the electronic mail transmitted to the address inside the electronic mail typestyle processing device which is allocated severally to the registered user, and the destination address of the electronic mail received by the receiving section is rewritten by the address rewriting section into the electronic mail address, which is the actual destination extracted by the address extracting section.

According to the electronic mail typestyle processing device of the present invention, text of an electronic mail transmitted by an electronic mail sender by use of a general electronic mail transmission/receipt terminal is automatically subjected to imaging with a typestyle reflecting personality of the sender of the electronic mail and is distributed to an electronic mail receiver or disclosed as a Web page. Therefore, the sender of the electronic mail can send the electronic mail reflecting his own personality by transmitting the electronic mail while utilizing an electronic mail distribution system using this electronic mail typestyle processing device, without requirements of installing any special functions in the electronic mail transmission/receipt terminal or performing any special operations. Moreover, the receiver of the electronic mail can browse the text of the electronic mail in the typestyle reflecting the personality of the sender of the electronic mail while utilizing a general electronic mail transmission/receipt terminal, without requirements of installing any special function in the electronic mail transmission/receipt terminal or performing any special operations.

Moreover, when the electronic mail address of the registered user is used as the identifier for identifying the registered user registered as a user eligible for receiving typestyle processing by this electronic mail typestyle processing device, the registered user is not required to put special code data into the electronic mail in order to obtain authorization by the electronic mail typestyle processing device, whereby operations are more simplified.

Moreover, if the destination-based process propriety correspondence table for specifying as to whether or not the typestyle processing is performed for each destination of the electronic mail is stored in this electronic mail typestyle processing device and judgment is made as to whether or not the typestyle of the text of the electronic mail is processed depending on the destination with reference to this destination-based process propriety correspondence table, it is possible to transmit the electronic mail in the typestyle reflecting the personality of the sender only to a destination of close relationship or a destination to send an electronic mail of informal contents while not requiring a complicated operation at the sender of the electronic mail side.

Moreover, if the address inside the electronic mail typestyle processing device is allocated severally to the registered user registered as a user eligible for receiving the typestyle processing by the electronic mail typestyle processing device, and if the sender of the electronic mail transmits the electronic mail to his own address inside the electronic mail typestyle processing device and the electronic mail typestyle processing device extracts the electronic mail address of the receiver which is the actual address from the received electronic mail and transmits the electronic mail subjected to the typestyle processing to the receiver, it is possible to utilize a generally-used mail server as a mail server for transmission and receipt of the electronic mails without requirements of installing any special additional functions.

Moreover, in this case, the address of the registered user inside the electronic mail typestyle processing device, which is described as the destination of the electronic mail, is rewritten into the electronic mail address of the receiver of the electronic mail by the electronic mail typestyle processing device. Accordingly, the address of the registered user inside the electronic mail typestyle processing device is not disclosed to the receiver of the electronic mail. Therefore, even if the address of the registered user inside the electronic mail typestyle processing device is used as the identifier for identifying the registered user, it is possible to forestall unauthorized use of the electronic mail typestyle processing device by a third party other than the registered user.

### BRIEF DESCRIPTION OF THE DRAWINGS

FIG. 1 is a system configuration diagram of an electronic mail distribution system using an electronic mail typestyle processing server adopting the present invention.

FIG. 2 is a view showing a hardware configuration of the electronic mail typestyle processing server.

FIG. 3 is a functional block diagram of the electronic mail typestyle processing server.

FIG. 4 is a functional block diagram showing details of a text typestyle processing section of the electronic mail typestyle processing server.

FIGS. 5A and 5B are views showing a data structure of an electronic mail to be transmitted and received in the electronic mail distribution system.

FIG. 6 is a view showing one example of a screen displayed on an electronic mail transmission client terminal upon producing an electronic mail.

FIG. 7 is a view showing one example of a screen displayed on an electronic mail receiving client terminal upon receiving an electronic mail.

FIG. 8 is a set of flowcharts showing processes in the electronic mail distribution system, in which processes at the electronic mail transmission client terminal and processes at a transmission mail server are illustrated together.

FIG. 9 is a set of flowcharts showing the processes in the electronic mail distribution system, in which processes at the transmission mail server, processes at the electronic mail typestyle processing server and a process at a receiving mail server are illustrated together.

FIG. 10 is another set of flowcharts showing the processes in the electronic mail distribution system, in which processes at the receiving mail server and processes at the electronic mail receiving client terminal are illustrated together.

FIG. 11 is a functional block diagram of another electronic mail typestyle processing server adopting the present invention.

FIG. 12 is a view showing one example of a destination-based process propriety correspondence table to be stored in a correspondence table storing section of the other electronic mail typestyle processing server.

FIG. 13 is a functional block diagram showing details of a text typestyle processing section of still another electronic mail typestyle processing server adopting the present invention.

FIG. 14 is a view showing one example of a screen displayed on the electronic mail transmission client terminal upon producing an electronic mail.

FIG. 15 is a view showing one example of a screen displayed on the electronic mail receiving client terminal upon receiving an electronic mail.

FIG. 16 is a functional block diagram showing details of a text typestyle processing section of yet another electronic mail typestyle processing server adopting the present invention.

FIG. 17 is a view showing one example of a screen displayed on the electronic mail transmission client terminal upon producing an electronic mail.

FIG. 18 is a view showing one example of a screen displayed on the electronic mail receiving client terminal upon receiving an electronic mail.

FIG. 19 is a view showing one example of a screen displayed on a Web browser upon having access to a Web page.

### THE DETAILED DESCRIPTION OF THE PREFERRED EMBODIMENTS

Now, description will be made regarding preferred embodiments of the present invention with reference to the accompanying drawings.

(First Embodiment)

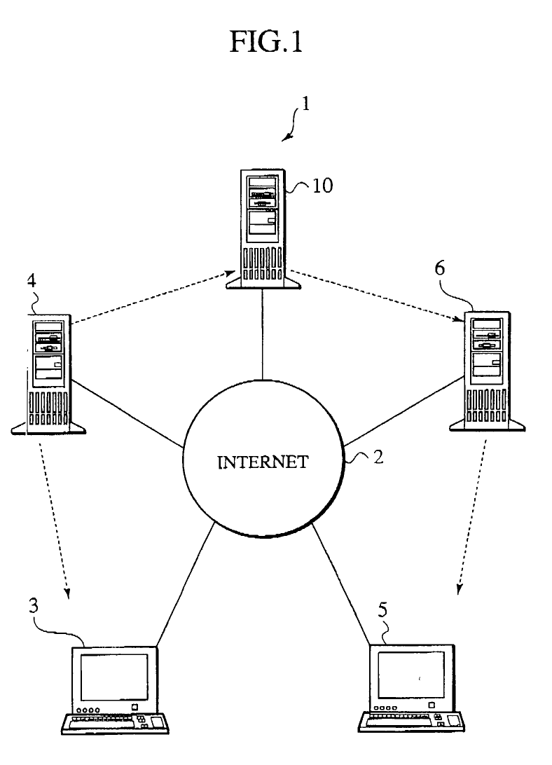

An electronic mail typestyle processing device according to the present invention is used as an electronic mail typestyle processing server 10 in an electronic mail distribution system 1 as shown in FIG. 1, for example.

The electronic mail distribution system 1 shown in FIG. 1 is composed in a manner that an electronic mail transmission client terminal 3, a transmission mail server 4, an electronic mail receiving client terminal 5, a receiving mail server 6 and the electronic mail typestyle processing server 10 adopting the present invention are mutually connected via the Internet 2 which is information transmission means. Note that description is made herein regarding an example that the transmission mail server 4, the receiving mail server 6 and the electronic mail typestyle processing server 10 are realized with individual pieces of hardware. However, these servers may be also realized on physically one piece of hardware by software corresponding to the respective servers.

As for the electronic mail transmission client terminal 3, for example, a personal computer is used. This electronic mail transmission client terminal 3 includes a function for editing text of an electronic mail, and a function for transmitting the produced electronic mail by communication with the transmission mail server 4. Moreover, information necessary for transmitting the electronic mail to the transmission mail server 4, specifically, a domain name and an IP address of the transmission mail server 4, an account name for a user to log in the transmission mail server 4, an authorization password and the like, is stored in the electronic mail transmission client terminal 3.

A sender of the electronic mail edits the text of the electronic mail and transmits the electronic mail by use of this electronic mail transmission client terminal 3. Such operations by the sender of the electronic mail are nothing more than a general case of transmission an electronic mail. Specifically, upon utilizing the electronic mail distribution system 1, the sender of the electronic mail is not required to perform any special operations with the electronic mail transmission client terminal 3. Meanwhile, data stored in the electronic mail transmission client terminal 3 and the functions possessed by the electronic mail transmission client terminal 3 are those normally equipped on a terminal for performing transmission and receipt of electronic mails. Accordingly, it is not necessary to install special software on the electronic mail transmission client terminal 3.

Besides the personal computer, other terminals having an electronic mail transmission function such as a personal data assistant (a PDA), a mobile phone, a domestic fixed telephone set, a home game machine and a television set, for example, can be also used for the electronic mail transmission client terminal 3.

The transmission mail server 4 includes a function for receiving the electronic mail transmitted from the electronic mail transmission client terminal 3, and a function for transmitting the received electronic mail either to a destination of the electronic mail or to the electronic mail typestyle processing server 10. Moreover, the account name and the authorization password of a user (the sender of the electronic mail) registered as the user eligible for receiving an electronic mail transmission service by the transmission mail server 4, a flag for indicating as to whether or not the sender of the electronic mail is registered as the user eligible for receiving a typestyle processing service by the electronic mail typestyle processing server 10, and the like are stored in the transmission mail server 4.

This transmission mail server 4 possesses functions similar to those possessed by a general mail server for performing an electronic mail transmission service. A difference from the general mail server is that the transmission mail server 4 stores the flag indicating as to whether or not the sender of the electronic mail is registered as the user eligible for receiving the typestyle processing service by the electronic mail typestyle processing server 10.

As for the electronic mail receiving client terminal 5, for example, a personal computer is used as similar to the electronic mail transmission client terminal 3. This electronic mail receiving client terminal 5 includes a function for receiving the electronic mail by communication with the receiving mail server 6, and a function for allowing an electronic mail receiver to browse contents of the received electronic mail. Moreover, information necessary for receiving the electronic mail from the receiving mail server 6, specifically, a domain name and an IP address of the receiving mail server 6, an account name for the receiver of the electronic mail to log in the receiving mail server 6, an authorization password and the like, is stored in the electronic mail receiving client terminal 5.

The receiver of the electronic mail receives the electronic mail and put the contents thereof onto a screen for browsing by use of this electronic mail receiving client terminal 5. Such operations by the receiver of the electronic mail are nothing more than a general case of receiving an electronic mail. Specifically, upon utilizing the electronic mail distribution system 1, the receiver of the electronic mail is not required to perform any special operations with the electronic mail receiving client terminal 5. Meanwhile, data stored in the electronic mail receiving client terminal 5 and the functions possessed by the electronic mail receiving client terminal 5 are those normally equipped on a terminal for performing transmission and receipt of electronic mails. Accordingly, it is not necessary to install special software on the electronic mail receiving client terminal 5.

Besides the personal computer, other terminals having an electronic mail transmission function such as a personal data assistant (a PDA), a mobile phone, a domestic fixed telephone set, a home game machine and a television set, for example, can be also used for the electronic mail receiving client terminal 5.

The receiving mail server 6 includes a function for receiving an electronic mail transmitted from a general mail server or the electronic mail typestyle processing server 10, and a function for transmitting the received electronic mail to the electronic mail receiving client terminal 5. Moreover, an account name and an authorization password for a user (the receiver of the electronic mail) registered as the user eligible for receiving an electronic mail reception service by the receiving mail server 6, and the like are stored in the receiving mail server 6.

This receiving mail server 6 possesses functions similar to those possessed by a general mail server for performing an electronic mail reception service. Moreover, data similar to those in the general mail server for performing the electronic mail reception service are stored in the receiving mail server 6.

The electronic mail typestyle processing server 10 adopting the present invention includes a function for receiving the electronic mail transmitted from the transmission mail server 4, a function for providing the text of the received electronic mail with typestyle processing and for replacing the original text with processed text, and a function for transmitting the electronic mail obtained by the processing to the receiving mail server 6 corresponding to the destination thereof. Moreover, information such as a domain name and an IP address for specifying the transmission mail server 4 used by the sender of the electronic mail (the registered user) registered as the user eligible for receiving the typestyle processing service by the electronic mail typestyle processing server 10, and information for identifying (an identifier) the registered user registered as the user eligible for receiving the typestyle processing service by the electronic mail typestyle processing server 10, specifically, such as an electronic mail address of the registered user for example, are stored in the electronic mail typestyle processing server 10.

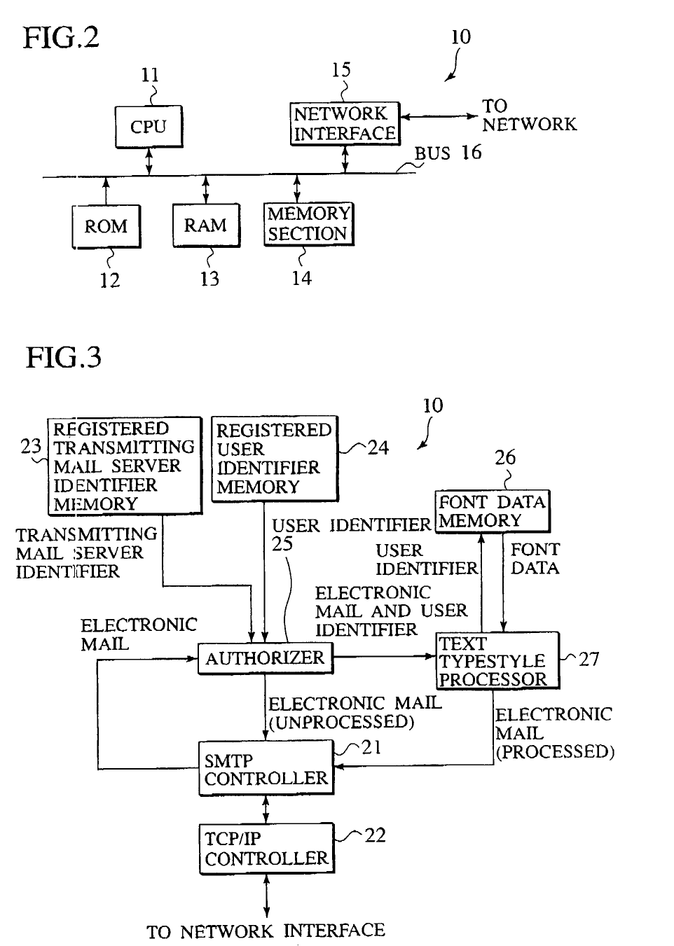

A concrete hardware configuration of the electronic mail typestyle processing server 10 is arranged as shown in FIG. 2, for example. Specifically, this electronic mail typestyle processing server 10 includes a central processing unit (a CPU) 11, a read-only memory (a ROM) 12, a random access memory (a RAM) 13, a memory section 14 and a network interface 15, and has a structure that those devices are mutually connected with a bus 16.

This electronic mail typestyle processing server 10 is designed for realizing various functions as shown in a functional block diagram of FIG. 3, by the CPU 11 executing control programs stored in the ROM 12 and typestyle processing programs as well as communication programs stored in the memory section 14 while utilizing the RAM 13 as a work area. Specifically, this electronic mail typestyle processing server 10 executes the foregoing programs with the CPU 11 for obtaining a function as an SMTP controller 21, a function as a TCP/IP controller 22, a function as a registered transmission mail server identifier memory 23, a function as a registered user identifier memory 24, a function as an authorizer 25, a function as a font data memory 26 and a function as a text typestyle processor 27, respectively.

The SMTP controller 21 is provided for controlling transmission and receipt of an electronic mail in accordance with the simple mail transmit protocol (SMTP) which is a communication protocol for realizing transmission and receipt of electronic mails using the Internet 2. SMTP is one of application protocols included in the transmission control protocol/internet protocol (TCP/IP), which specifies as to how a mail system on a transmission side and a mail system on a receiving side interact with each other, thus defining control message formats to be exchanged for transmit of an electronic mail. This SMTP is normally loaded on the transmission mail server 4 as well as on the receiving mail server 6, and the SMTP controller 21 on the electronic mail typestyle processing server 10 controls transmission and receipt of electronic mails in accordance with SMTP therebetween.

The TCP/IP controller 22 is provided for controlling transmission and receipt of an electronic mail using the Internal 2 while interlocking with the SMTP controller 21. Specifically, since SMTP operates on an upper layer of TCP/IP, the electronic mail transmitted from the transmission mail server 4 is inputted to the SMTP controller 21 via the TCP/IP controller 22 provided for controlling TCP/IP, and the electronic mail, in which a typestyle of the text thereof is processed by the text typestyle processor 27, is transmitted to the receiving mail server 6 corresponding to the destination of the electronic mail via the SMTP controller 21 and the TCP/IP controller 22.

The registered transmission mail server identifier memory 23 is provided for storing the identifier of the transmission mail server 4 constituting the electronic mail distribution system 1. Specifically, as described above, the flag indicating as to whether or not an electronic sender is a registered user eligible for receiving the typestyle processing service by the electronic mail typestyle processing server 10 is stored in the transmission mail server 4 for each account of the sender of the electronic mail. Accordingly, the transmission mail server 4 prepared for transmitting the electronic mail to the electronic mail typestyle processing server 10 is registered, whereby the identifier thereof is stored in the registered transmission mail server identifier memory 23 of the electronic mail typestyle processing server 10.

The registered user identifier memory 24 is provided for storing the identifier of the user eligible for receiving the typestyle processing service by the electronic mail typestyle processing server 10. Specifically, the user who receives the typestyle processing service by the electronic mail typestyle processing server 10 is registered in advance (as the registered user), and the electronic mail address of the registered user, for example, is stored in the registered user identifier memory 24 of the electronic mail typestyle processing server 10 as the identifier to indicate the registered user. As the identifier of the registered user, aside from the electronic mail address, any information such as an ID number individually provided with the registered user is acceptable so far as such information can identify the registered user. However, in the case when the electronic mail address is utilized as the identifier of the registered user, it is advantageous from a viewpoint that the registered user does not have to write down another identifier in the electronic mail for obtaining authorization by the electronic mail typestyle processing server 10.

The authorizer 25 is provided for performing authorization processing with the identifier of the transmission mail server 4 stored in the registered transmission mail server identifier memory 23 and the identifier of the registered user stored in the registered user identifier memory 24. To be more precise, the authorizer 25 judges as to whether or not the received electronic mail is an electronic mail which is subject to the typestyle processing service by the electronic mail typestyle processing server 10, depending on the fact as to whether or not data constituting the electronic mail received via the TCP/IP controller 22 and the SMTP controller 21 includes the identifier of the transmission mail server 4 to be stored in the registered transmission mail server identifier memory 23 as well as the identifier of the registered user to be stored in the registered user identifier memory 24. The electronic mail typestyle processing server 10 can exclude an electronic mail transmitted unlawfully from an unregistered transmission mail server by the authorizer 25 performing authorization depending on the identifier of the transmission mail server 4. In addition, the electronic mail typestyle processing server 10 can transmit an electronic mail transmitted from an unregistered user to the receiving mail server 6 without providing the typestyle processing service, by performing authorization depending on the identifier of the registered user.

The font data memory 26 is provided for storing data for a user typestyle font, which is a font reflecting personality of the registered user. The user typestyle font data are stored in the font data memory 26 for each registered user registered in advance. If a font created by the registered user's own hand writing is used as the user typestyle font, the registered user can transmit the electronic mail while replacing the typestyle of the electronic mail text with a hand-written typestyle.

Processing to store the user typestyle font in the font data memory 26 may be carried out simultaneously with registration of the user, for example. To be more precise, the electronic mail typestyle processing server 10 discloses a user registration page in a Web page style, for example. Then, the user performs user registration for receiving the typestyle processing service by the electronic mail typestyle processing server 10, by means of having access to this user registration page while using a Web browser normally installed on the electronic mail transmission client terminal 3 and inputting specified information such as the user name, the electronic mail address and the like, into the user registration page. In this event, the user transmits the data for the user typestyle font which is the typestyle reflecting his own personality from this user registration page toward the electronic mail typestyle processing server 10 in accordance with communication protocols such as the hypertext transfer protocol (HTTP) and the file transfer protocol (FTP). Thereafter, the electronic mail typestyle processing server 10 specifies the electronic address or the like written in the user registration page as the user identifier, and stores the user typestyle font transmitted from the user into the font data memory 26 in association with the user identifier.

Moreover, in the case when the user registration is to be accepted by an electronic mail, the user may transmit the data for the user typestyle font, which is the font reflecting his personality, to the typestyle processing server 10 as an attached file to this electronic mail. In this case, the electronic mail typestyle processing server 10 performs user registration based on the information written in the electronic mail and specifies the electronic mail address of the user being the sender's address, for example, as the user identifier. Thereafter, the electronic mail typestyle processing server 10 stores the user typestyle font in the attached file into the font data memory 26 in association with the user identifier. As it will be described in detail later, in the case when the user address inside the electronic mail typestyle processing server 10 is allocated to the user and the user transmits the electronic mail to this user address inside the electronic mail typestyle processing server 10, the electronic mail typestyle processing server 10 may specify the user address being a destination address as the user identifier and store the user typestyle font in the attached file into the font data memory 26 in association with the user identifier.

Moreover, in the case when user registration is accepted by a registration paper in the user's handwriting, the user writes down specified items required for registration as well as sample characters in handwriting, for example, and sends the registration paper to a service provider who manages the electronic mail typestyle processing server 10 by mail. Upon receipt of the registration paper from the user, the service provider performs processing for user registration with the electronic mail typestyle processing server 10 based on the information written in the registration paper. In addition, the service provider creates the user typestyle font based on the sample characters written in the registration paper and performs processing to store the user typestyle font into the font data memory 26 of the electronic mail typestyle processing server 10 in association with the user identifier. In this case, the user typestyle font is created by the service provider managing the electronic mail typestyle processing server 10 and the user typestyle font created will be stored into the font data memory 26 in association with the user identifier. Accordingly, the user does not have to create the user typestyle font in advance.

Furthermore, in the case of performing the processing to store the user typestyle font into the font data memory 26 after user registration is completed, for example, the user may send the user typestyle font data to the service provider managing the electronic mail typestyle processing server 10 by mail while storing the data in a portable storage medium such as a memory card, whereby the service provider may read out the user typestyle font data out of the mailed portable memory to perform processing for storing the user typestyle font data into the font data memory 26 of the electronic mail typestyle processing server 10 in association with the user identifier.

The text typestyle processor 27 is provided for processing the text of the electronic mail judged by the authorizer 25 as being subject to the typestyle processing service by the electronic mail typestyle processing server 10 into character image data in the typestyle corresponding to the user typestyle font stored in the font data memory 26. A format of the character image data may be a bitmap format or a page description language generally used.

Now, description will be made in further detail regarding the text typestyle processor 27.

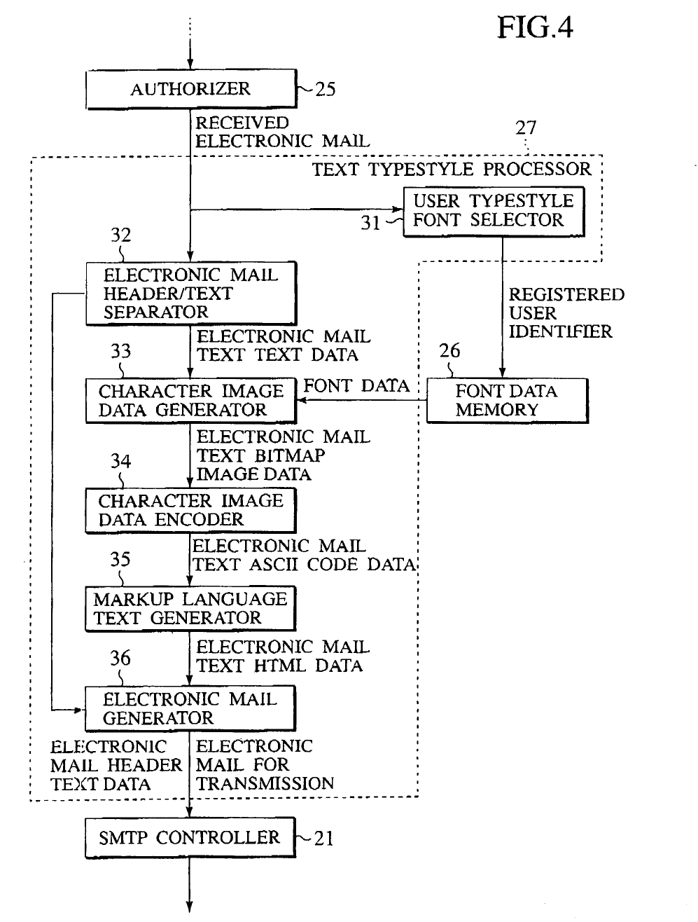

As shown in FIG. 4, the text typestyle processor 27 includes a user typestyle font selector 31, an electronic mail header-text separator 32, a character image data generator 33, a character image data encoder 34, a markup language text generator 35 and an electronic mail generator 36.

The user typestyle font selector 31 recognizes the identifier of the registered user contained in the electronic mail judged by the authorizer 25 as being subject to the typestyle processing service by the electronic mail typestyle processing server 10, and selects the user typestyle font corresponding to the recognized identifier of the registered user out of user typestyle fonts stored in the font data memory 26. The user typestyle font data selected by this user typestyle font selector 31 will be sent to the character image data generator 33.

The electronic mail header-text separator 32 performs processing to separate a header portion and a text portion of the electronic mail judged by the authorizer 25 as being subject to the typestyle processing service by the electronic mail typestyle processing server 10. Note that a data structure of the electronic mail will be described later in detail.

The character image data generator 33 rasterizes the text portion of the electronic mail separated out of the header portion by the electronic mail header-text separator 32 with the user typestyle font selected by the user typestyle font selector 31, thus generating character image data such as bitmap data.

The character image data encoder 34 converts a data structure of the character image data generated by the character image generator 33 into a data structure suitable for an electronic mail. Specifically, as the character image data generated by the character image data generator 33 are binary data, the character image data encoder 34 converts the character image data in a binary format into an ASCII code format by use of an encoding method such as Base64.

The markup language text generator 35 adds HTML tags and the like to the character image data replaced with the ASCII code format by the character image data encoder 34, for specifying designs of displaying the character image data constituting the electronic mail text on the electronic mail receiving client terminal 5.

The electronic mail generator 36 adds an electronic mail header (such as “From”, “To” and “Subject”) separated by the electronic mail header-text separator 32 to HTML data constituting the electronic mail text, that is, the character image data with addition of the HTML tags. In this way, a mail for transmission is created in which the data constituting the text of the electronic mail judged by the authorizer 25 as being subject to the typestyle processing service by the electronic mail typestyle processing server 10 are replaced with the character image data rasterized with the user typestyle reflecting the personality of the registered user. Thereafter, the mail for transmission created by this electronic mail generator 36 will be transmitted to the receiving mail server 6 corresponding to the destination of the electronic mail via the SMTP controller 21 and the TCP/IP controller 22.

Now, description will be made regarding the data structure of the electronic mail to be transmitted and received in the electronic mail distribution system 1.

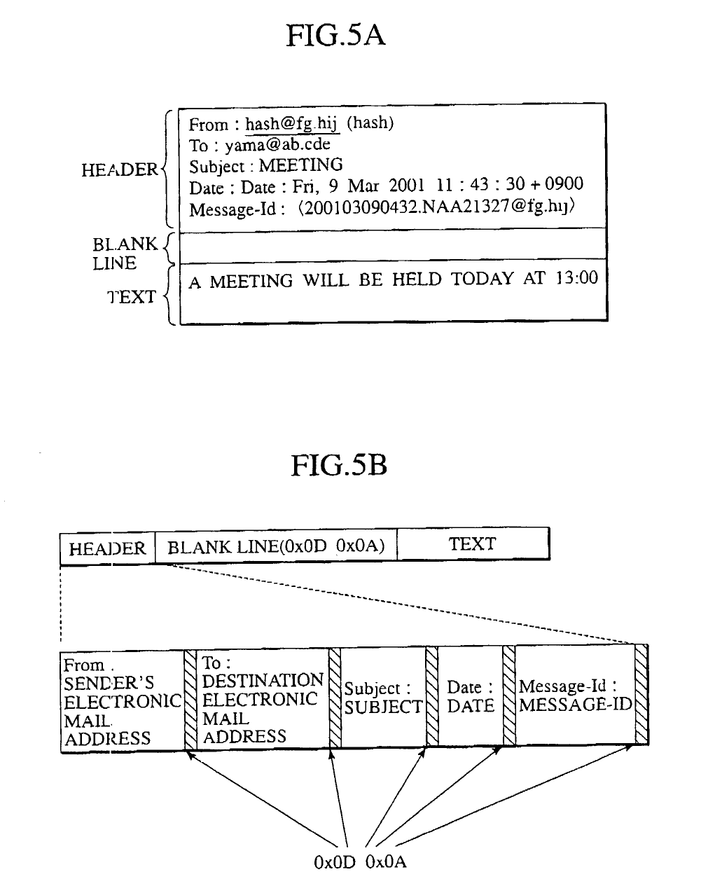

As shown in FIG. 5A and FIG. 5B, the electronic mail to be transmitted and received in the electronic mail distribution system 1 is reproduced by two portions of a header and the text. These header and text are separated by a blank line (a linefeed code 0x0D 0x0A).

The header is reproduced by text lines extending from a forefront of the electronic mail to a first blank line thereof, and information necessary for transmission of the electronic mail is written therein. To be more precise, the header is reproduced by a “From” line, a “To” line, a “Subject” line, a “Date” line and a “Message-ID” line.

Information indicating the sender of the electronic mail is described in the “From” line, in which, for example, the electronic mail address of the sender is specified and the user name is specified in a bracket. In the case of defining the electronic mail address of the sender as the identifier of the registered user, the electronic mail address specified in this “From” line, specifically, “hash@fg.hij” as shown in the example of FIG. 5A becomes the identifier of the registered user.

The electronic mail address of the destination of the electronic mail is specified in the “To” line. In the case of specifying a plurality of destinations, each electronic mail address of the destination is divided by a comma.

A subject of the electronic mail is described in the “Subject” line.

A date and time of transmission of the electronic mail is described in the “Date” line.

An individual ID to the electronic mail created by use of serial numbers or the like is described in the “Message-ID” line. This individual ID is generated by use of the date and time of transmission, the name of the electronic mail transmission client terminal 3 used for transmission of the electronic mail and the like, so as to be only one ID in the world.

Each of the above-described lines in the header is divided by a linefeed code (0x0D 0x0A). Note that description is made herein regarding an example of a system which uses the code 0x0D 0x0A ([CR] [LF]) as the linefeed code. However, depending on systems, there are cases of using [LF] only or [CR] only as the linefeed code.

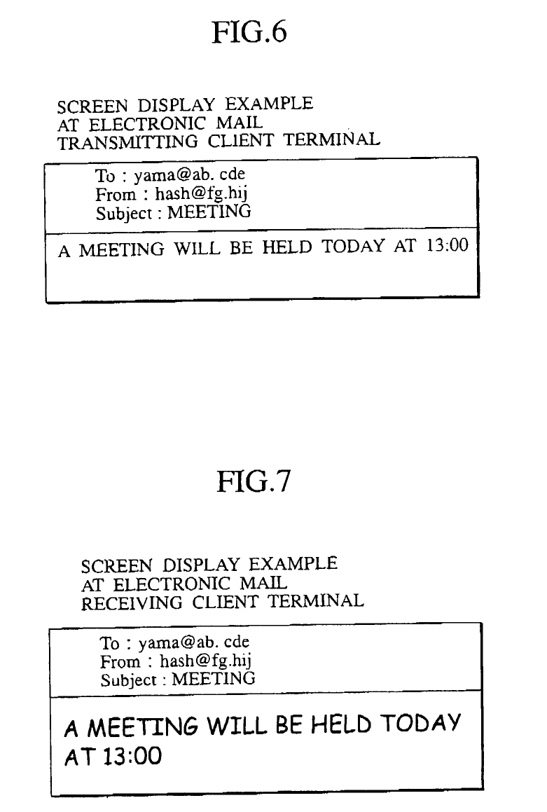

When the electronic mail of the above-described data structure is created, a screen shown in FIG. 6, for example, will be displayed on the electronic mail transmission client terminal 3. In the screen as shown in FIG. 6, an upper part thereof illustrates the header of the electronic mail and a lower part thereof illustrates the text.

In this screen to be displayed on the electronic mail transmission client terminal 3, the electronic mail address of the destination of the electronic mail is specified in the “To” line, the electronic mail address of the sender of the electronic mail is specified in the “From” line and the subject of the electronic mail is specified in the “Subject” line. In addition, in the screen to be displayed on the electronic mail transmission client terminal 3, text indicating a message such as “A meeting will be held today at 13:00” will be written down in a text column in a normal typestyle using a normal font installed on the electronic mail transmission client terminal 3.

In the meantime, a screen shown in FIG. 7, for example, will be displayed on the electronic mail receiving client terminal 5 which received the above-described electronic mail via the electronic mail typestyle processing server 10. In the screen shown in FIG. 7, an upper part thereof illustrates the header of the electronic mail and a lower part thereof illustrates the text.

In this screen to be displayed on the electronic mail receiving client terminal 5, the same contents as the screen displayed on the electronic mail transmission client terminal 3 are displayed in a header column thereof. Moreover, in the screen to be displayed on the electronic mail receiving client terminal 5, the text indicating the message such as “A meeting will be held today at 13:00” will be displayed in a text column thereof as the character image data in the typestyle reflecting the personality of the sender of the electronic mail (the registered user).

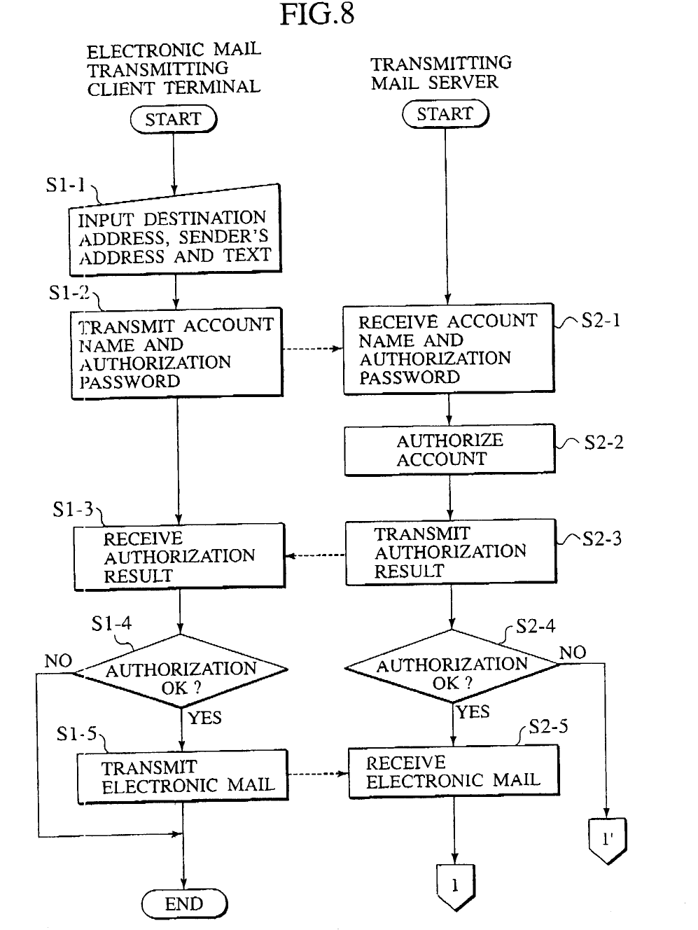

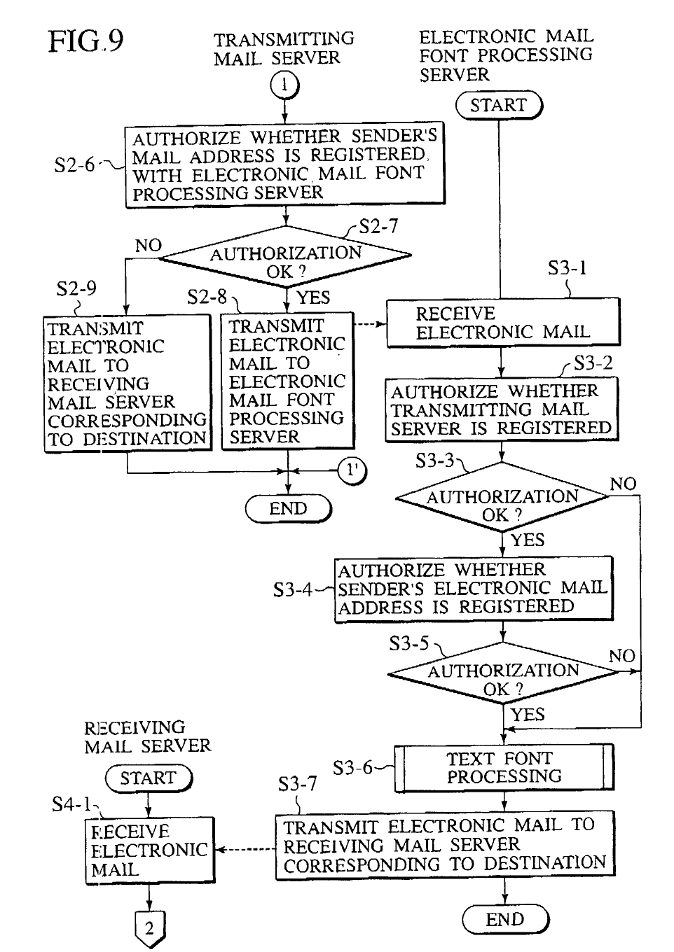

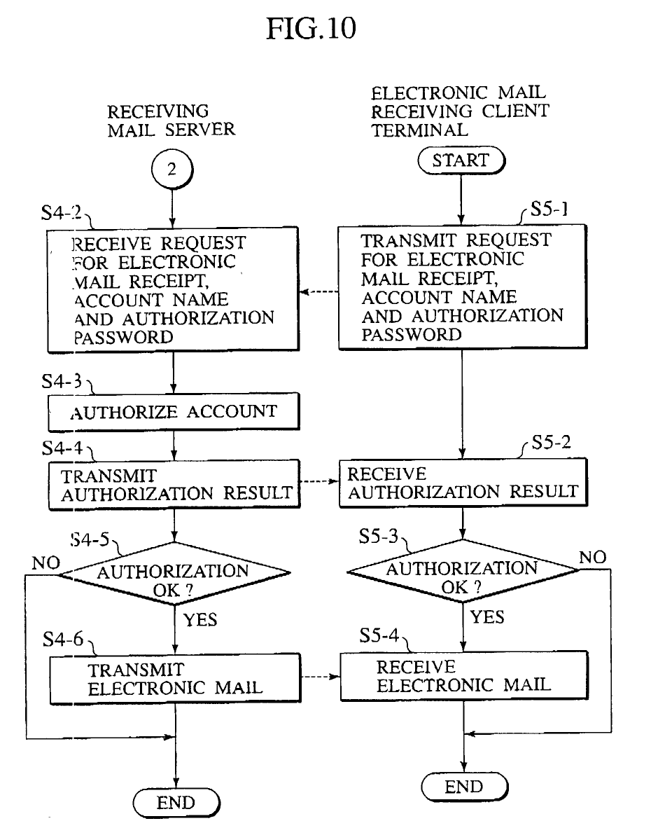

Next, description will be made regarding process flow in the electronic mail distribution 1 thus composed with reference to FIG. 8 to FIG. 10. Note that FIG. 8 illustrates process flow at the electronic mail transmission client terminal 3 as well as the transmission mail server 4, FIG. 9 illustrates process flow at the transmission mail server 4, the electronic mail typestyle processing server 10 and the receiving mail server 6, and FIG. 10 illustrates process flow at the receiving mail server 6 and the electronic mail receiving client terminal 5.

In the case of performing transmission and receipt of the electronic mail with the electronic mail distribution system 1, first as shown in FIG. 8, the electronic mail address of the destination, the electronic mail address of the sender and the text of the electronic mail are inputted to a given input screen of the electronic mail transmission client terminal 3 in Step S1-1.

Upon completion of inputting these specified items, next in Step S1-2, the account name and the authorization password for logging in the transmission mail server 4 is transmitted from the electronic mail transmission client terminal 3 to the transmission mail server 4 via the Internet 2.

In Step S2-1, the account name and the authorization password transmitted from the electronic mail transmission client terminal 3 is received by the transmission mail server 4. Then, upon receipt of the account name and the authorization password transmitted from the electronic mail transmission client terminal 3 by the transmission mail server 4, account authorization is performed in Step S2-2, thus confirming as to whether or not the sender of the electronic mail is the user registered as the user eligible for receiving an electronic mail transmission service by the transmission mail server 4. Then in Step S2-3, a result of the authorization is transmitted to the electronic mail transmission client terminal 3 via the Internet 2.

The authorization result transmitted from the transmission mail server 4 is received by the electronic mail transmission client terminal 3 in Step S1-3. Then, in Step S1-4, the electronic mail transmission client terminal 3 judges as to whether or not the sender of the electronic mail is authorized as the user eligible for receiving the electronic mail transmission service by the transmission mail server 4. When the user is judged as the authorized user, then in Step S1-5, the electronic mail created by the sender of the electronic mail is transmitted to the transmission mail server 4 via the Internet 2, whereby the processes at the electronic mail transmission client terminal 3 are completed.

On the contrary, if the sender of the electronic mail is not judged as the authorized user eligible for receiving the electronic mail transmission service by the transmission mail server 4 in Step S1-4, the processes at the electronic mail transmission client terminal 3 are completed without transmitting the electronic mail to the transmission mail server 4.

In the meantime, in Step S2-4, the transmission mail server 4 judges as to whether or not the sender of the electronic mail is authorized as the user eligible for receiving the electronic mail transmission service by the transmission mail server 4. When the user is judged as the authorized user, then in Step S2-5, the electronic mail transmitted from the electronic mail transmission client terminal 3 is received.

On the contrary, if the sender of the electronic mail is not judged as the authorized user eligible for receiving the electronic mail transmission service by the transmission mail server 4 in Step S2-4, the processes at the transmission mail server 4 are completed without receiving the electronic mail.

When the electronic mail transmitted from the electronic mail transmission client terminal 3 is received by the transmission mail server 4, then in Step S2-6 as shown in FIG. 9, authorization is performed in accordance with the flag stored in the transmission mail server 4 in advance, thus confirming as to whether or not the sender of the electronic mail is registered as the user eligible for receiving the typestyle processing service by the electronic mail typestyle processing server 10.

Thereafter, in Step S2-7, judgment is made as to whether or not the sender of the electronic mail is authorized as the user eligible for receiving the typestyle processing service by the electronic mail typestyle processing server 10. When the user is judged as the authorized user, then in Step S2-8, the electronic mail received from the electronic mail transmission client terminal 3 is transmitted to the electronic mail typestyle processing server 10 via the Internet 2, whereby the processes at the transmission mail server 4 are completed.

On the contrary, if the sender of the electronic mail is not judged as the authorized user eligible for receiving the typestyle processing service by the electronic mail typestyle processing server 10, then in Step S2-9, the electronic mail received from the electronic mail transmission client terminal 3 is transmitted to the receiving mail server 6 corresponding to the destination of this electronic mail via the Internet 2, whereby the processes at the transmission mail server 4 are completed.

The electronic mail transmitted from the transmission mail server 4 in Step S2-8 is received by the network interface 15 of the electronic mail typestyle processing server 10 in Step S3-1 in accordance with control by the TCP/IP controller 22 and by the SMTP controller 21. Thereafter, upon receipt of the electronic mail transmitted from the transmission mail server 4, the authorizer 25 of the electronic mail typestyle processing server 10 refers to the registered transmission mail server identifier memory 23 in Step S3-2. Here, authorization is performed according to the identifier of the registered transmission mail server stored in this registered transmission mail server identifier memory 23, whereby confirmation is made as to whether or not the transmission mail server 4 is registered as the mail server (the registered transmission mail server) being subject to the typestyle processing service by the electronic mail typestyle processing server 10.

Thereafter, judgment is performed as to whether or not the transmission mail server 4 is authorized as the registered transmission mail server in Step S3-3. When the transmission mail server 4 is judged as the authorized mail server, then in Step S3-4, the authorizer 25 refers to the registered user identifier memory 24. Here, authorization is performed according to the identifier of the registered user stored in this registered user identifier memory 24, whereby confirmation is made as to whether or not the sender of the electronic mail is registered as the user (the registered user) eligible to receiving the typestyle processing service by the electronic mail typestyle processing server 10.

Then in Step S3-5, judgment is made as to whether or not the sender of the electronic mail is authorized as the registered user. When the sender is judged as the authorized user, then in Step S3-6, the typestyle of text of the electronic mail received is processed into the typestyle corresponding to the user typestyle font stored in the font data memory 26, which reflects the personality of the registered user.

Specifically, when the sender of the electronic mail is authorized as the registered user, firstly, the identifier of the registered user contained in the received electronic mail is recognized by the user typestyle font selector 31, whereby the user typestyle font corresponding to the identifier of the registered user being recognized is selected out of the user typestyle fonts stored in the font data memory 26. Moreover, the header portion and the text portion of the received electronic mail are separated by the electronic mail header-text separator 32.

Thereafter, the text portion of the received electronic mail is rasterized with the user typestyle font selected by the user typestyle font selector 31, whereby the character image data such as the bitmap data are generated.

Next, the character image data in the binary format, which are generated by the character image data generator 33, are replaced with the ASCII code format by the character image data encoder 34 while using the encoding method such as Base64, for example.

Next, the HTML tags and the like are added, by the markup language text generator 35, to the character image data which are replaced with the ASCII code format by the character image data encoder 34. Then, the electronic mail header, which was separated by the electronic mail header-text separator 32, is added to the HTML data constituting the electronic mail text by the electronic mail generator 36.

After a series of the foregoing processes by the text typestyle processor 27, the typestyle of the text of the received electronic mail is processed into the typestyle corresponding to the user typestyle font which reflects the personality of the registered user.

When the typestyle of the text of the electronic mail is processed into the typestyle corresponding to the user typestyle font, next in Step S3-7, this electronic mail in which the typestyle of the text is processed into the typestyle corresponding to the user typestyle font is transmitted to the receiving mail server 6 corresponding to the destination of this electronic mail via the Internet 2, whereby the processes at the electronic mail typestyle processing server 10 are completed.

On the contrary, if the transmission server 4 is judged as unauthorized as the registered transmission server in the above-described Step S3-3 and if the sender of the electronic mail is judged as unauthorized as the registered user in the above-described Step S3-5, then in Step S3-7, this electronic mail is transmitted to the receiving mail server 6 corresponding to the destination thereof via the Internet 2 without performance of the processing on the text typestyle of the electronic mail by the text typestyle processor 27, whereby the processes by the electronic mail typestyle processing server 10 are completed.

The electronic mail transmitted from the electronic mail typestyle processing server 10 in Step S3-7 is received by the receiving mail server 6 in Step S4-1.

When the electronic mail transmitted from the electronic mail typestyle processing server 10 is received by the receiving mail server 6, then in Step S5-1 as shown in FIG. 10, a request for electronic mail receipt as well as the account name and the authorization password for allowing the electronic mail receiving client terminal 5 to log in the receiving mail server 6 are transmitted from the electronic mail receiving client terminal 5 to the receiving mail server 6 via the Internet 2.

The request for electronic mail receipt, the account name and the authorization password which are transmitted from the electronic mail receiving client terminal 5 are received by the receiving mail server 6 in Step S4-2. Thereafter, when the request for electronic mail receipt, the account name and the authorization password transmitted from the electronic mail receiving client terminal 5 are received by the receiving mail server 6, account authorization is performed in Step S4-3, whereby confirmation is made as to whether or not the receiver of the electronic mail is the user registered as the user eligible for receiving an electronic mail reception service by the receiving mail server 6. Then in Step S4-4, a result of the authorization is transmitted to the electronic mail receiving client terminal 5 via the Internet 2.

The authorization result transmitted from the receiving mail server 6 is received by the electronic mail receiving client terminal 5 in Step S5-2. Thereafter, in Step S5-3, the electronic mail receiving client terminal 5 judges as to whether or not the receiver of the electronic mail is authorized as the user eligible for receiving the electronic mail reception service by the receiving mail server 6.

In the meantime, in Step S4-5, the receiving mail server 6 judges as to whether or not the receiver of the electronic mail is authorized as the user eligible for receiving the electronic mail reception service by the receiving mail server 6. When the user is judged as the authorized user, then in Step S4-6, the electronic mail in which the typestyle of the text is processed by the electronic mail typestyle processing server 10 into the typestyle corresponding to the user typestyle font reflecting the personality of the sender is transmitted to the electronic mail receiving client terminal 5 via the Internet 2, whereby the processes at the receiving mail server 6 are completed.

On the contrary, if the receiver of the electronic mail is judged as unauthorized as the user eligible for receiving the electronic mail reception service by the receiving mail server 6 in Step S4-5, the processes at the receiving mail server 6 are completed without transmitting the electronic mail to the electronic mail receiving client terminal 5.

Moreover, at the electronic mail receiving client terminal 5, if the receiver of the electronic mail is judged as the authorized user eligible for receiving the electronic mail reception service by the receiving mail server 6 in Step S5-3, the electronic mail transmitted from the receiving mail server 6, that is, the electronic mail in which the typestyle of the text is processed by the electronic mail typestyle processing server 10 into the user typestyle font reflecting the personality of the sender, is received in Step S5-4, whereby the processes at the electronic mail receiving client terminal 5 are completed.

On the contrary, if the receiver of the electronic mail is judged as unauthorized as the user eligible for receiving the electronic mail reception service by the receiving mail server 6 in Step S5-3, the processes at the electronic mail receiving client terminal 5 are completed without receiving the electronic mail from the receiving mail server 6.

As described above, in this electronic mail distribution system 1, the electronic mail typestyle processing server 10 adopting the present invention receives the electronic mail transmitted from a conventional terminal (the electronic mail transmission client terminal 3) for performing transmission and receipt of electronic mails via the transmission mail server 4. The electronic mail typestyle processing server 10 puts the text of the electronic mail into images using the user typestyle font reflecting the personality of the sender (the registered user) and transmits the electronic mail to a conventional terminal (the electronic mail receiving client terminal 5) for performing transmission and receipt of electronic mails via the receiving mail server 6, so as to allow the receiver to browse the images of the text of this electronic mail. Accordingly, it is feasible to perform transmission and receipt of the electronic mail represented with the user typestyle font reflecting the personality of the sender of the electronic mail appropriately, without using any special hardware for a terminal for performing transmission and receipt of the electronic mail or installing any special software or the user typestyle font on the terminal for performing transmission and receipt of the electronic mail.

Therefore, the sender of the electronic mail can transmit the electronic mail in the typestyle reflecting his own personality at anytime and from anywhere without performing any special operations, and the receiver of the electronic mail can browse the electronic mail in the typestyle reflecting the personality of the sender without performing any special operations.

(Second Embodiment)

Next, description will be made regarding a second embodiment adopting the present invention.

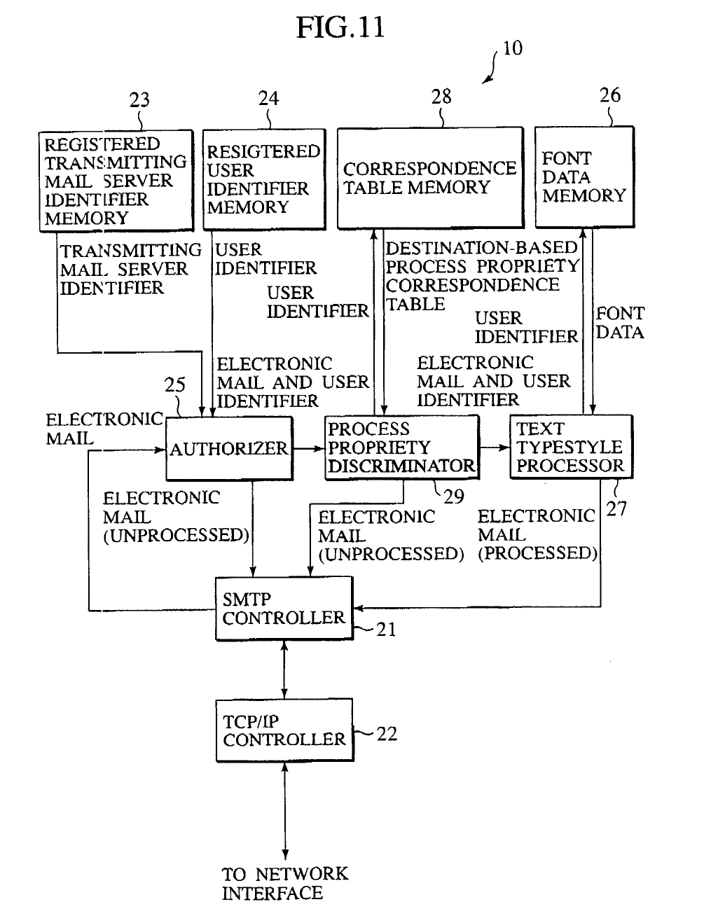

The electronic mail typestyle processing server 10 of this second embodiment has a hardware configuration (See FIG. 2) similar to that of the electronic mail typestyle processing server 10 described in the first embodiment, and is designed for realizing various functions as shown in a functional block diagram of FIG. 11, by the CPU 11 executing control programs stored in the ROM 12 and typestyle processing programs as well as communication programs stored in the memory section 14 while utilizing the RAM 13 as a work area. Specifically, this electronic mail typestyle processing server 10 executes the foregoing programs with the CPU 11 so as to include functions as the SMTP controller 21, the TCP/IP controller 22, the registered transmission mail server identifier memory 23, the registered user identifier memory 24, the authorizer 25, the font data memory 26 and the text typestyle processor 27, as similar to the electronic mail typestyle processing server 10 as described in the first embodiment. In addition to the foregoing, this electronic mail typestyle processing server 10 will further include a function as a correspondence table memory 28 and a function as a process propriety discriminator 29.

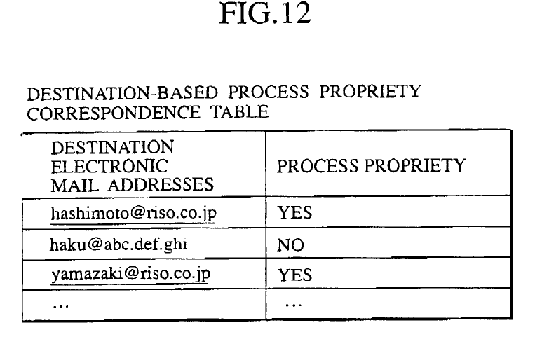

The correspondence table memory 28 is provided for storing a destination-based process propriety correspondence table such as one shown in FIG. 12, for example, in which an electronic mail address of destination and a specifier for specifying as to whether or not a typestyle of text of an electronic mail to be transmitted to the destination should be processed are linked together and recorded therein for each registered user who is registered as a user eligible for receiving a typestyle processing service by the electronic mail typestyle processing server 10. Specifically, a plurality of destinations (the electronic mail addresses) are registered with the electronic mail typestyle processing server 10 for respective registered users. In addition, each of the plurality of destinations is severally specified as to whether an electronic mail is transmitted thereto in a manner that a typestyle of text is processed by the electronic mail typestyle processing server 10, or an electronic mail is just transmitted thereto without processing a typestyle of text thereof, and such information of specification is stored in the correspondence table memory 28 as the destination-based process propriety correspondence table.

The process propriety discriminator 29 is provided for referring to the destination-based process propriety correspondence table stored in the correspondence table memory 28 for judging as to whether or not a destination of an electronic mail authorized by the authorizer 25, that is, the electronic mail from the registered user, is specified as the destination to which the electronic mail is transmitted after processing a typestyle of text of the electronic mail. If the electronic mail is judged by this process propriety discriminator 29 that the destination thereof is specified to which the electronic mail should be transmitted after processing the typestyle of the text thereof, the electronic mail will be supplied to the text typestyle processor 27 and transmitted to the destination after the typestyle of the text is processed. On the contrary, if the electronic mail is judged by this process propriety discriminator 29 that the destination thereof is specified so as to be unnecessary to process the typestyle of the text thereof, the electronic mail will be just transmitted to the destination without processing the typestyle of the text.

When the above-described electronic mail typestyle processing server 10 is used in the electronic mail distribution system 1, the electronic mail typestyle processing server 10 judges in accordance with a destination thereof as to whether the typestyle of text of an electronic mail from the registered user should be processed or not. Accordingly, it is feasible to transmit an electronic mail with text represented by use of the user typestyle font only to a destination with close relationship or to a destination to send electronic mails of informal contents, without requirements of complicated operations by the registered user (the sender of the electronic mail).

(Third Embodiment)

Next, description will be made regarding a third embodiment adopting the present invention.

The first embodiment or the second embodiment is provided with routing that the electronic mail always passes through the electronic mail typestyle processing server 10 adopting the present invention in the course of transmitting the electronic mail from the transmission mail server 4 to the receiving mail server 6. In this case, the transmission mail server 4 is required to set the electronic mail typestyle processing server 10 as a transmit address of the electronic mail transmitted from the electronic mail transmission client terminal 3. Therefore, it is necessary to install a special additional function on the transmission mail server 4.

In the third embodiment, description will be made regarding an example of realizing the typestyle processing service by the electronic mail typestyle processing server 10 adopting the present invention not by installing any special additional functions on the transmission mail server 4 but by using a mail server generally utilized.

In this example, inside the electronic mail typestyle processing server 10, a user address is allocated to each registered user registered as a user eligible for receiving the typestyle processing service by the electronic mail typestyle processing server 10. And upon transmission of an electronic mail from the electronic mail transmission client terminal 3, the sender of the electronic mail (the registered user) does not specify directly the electronic mail address of the receiver which is an actual destination, but the sender transmits the electronic mail to his own user address allocated inside the electronic mail typestyle processing server 10 instead. The sender specifies the electronic mail address of the receiver which is the actual destination either in the “Subject” in the header of the electronic mail for transmission or in the text thereof. In the case of specifying the actual destination inside the text, a format thereof should be decided in advance such as: describing the actual destination in a specific position such as on the top of the text; or describing the actual destination after a specific character string.

The electronic mail thus created is transmitted from the electronic mail transmission client terminal 3 to the transmission mail server 4. The transmission mail server 4 transmits the electronic mail to the address specified as the destination of the electronic mail, that is, to the user address of the sender (the registered user) allocated inside the electronic mail typestyle processing server 10. This is a normal operation provided on a usual mail server.

In this example, the electronic mail typestyle processing server 10 receives the electronic mail only if the user address allocated to the registered user inside the electronic mail typestyle processing server 10 is specified in the “To” line in the header of the electronic mail transmitted from the transmission mail server 4. Then the electronic mail typestyle processing server 10 performs processing of the typestyle of the text. In addition, the electronic mail typestyle processing server 10 extracts the electronic mail address specified in the “Subject” in the header of the received electronic mail or in the text thereof, that is, the electronic mail address of the receiver which is the actual destination. Then the electronic mail typestyle processing server 10 performs processing to rewrite the destination of the electronic mail into the electronic mail address of the receiver. Thereafter, the electronic mail typestyle processing server 10 transmits the electronic mail thus processed to the receiving mail server 6.

In this example, selection as to whether the typestyle of the text of the electronic mail is processed or not by receiving the service of the electronic mail typestyle processing server 10 depends on selection by the sender of the electronic mail as to whether or not his own user address allocated inside the electronic mail typestyle processing server 10 is specified. If the sender of the electronic mail does not wish to process the typestyle of the text, the user may specify the electronic mail address of the receiver, which is the actual destination, as the destination of the electronic mail as similar to a general case of transmitting an electronic mail. In this case, the transmission mail server 4 just sends the electronic mail from the electronic mail transmission client terminal 3 either to the receiving mail server 6 or to the electronic mail typestyle processing server 10 depending on the address specified as the destination. Accordingly, any special additional functions are not required.

Now, description will be made further in detail regarding the electronic mail typestyle processing server 10 used for the above-described electronic mail distribution system 1 with reference to FIG. 13. Note that FIG. 13 illustrates a functional block diagram of the text typestyle processor 27 in the electronic mail typestyle processing server 10.

In this electronic mail typestyle processing server 10, the text typestyle processor 27 further includes an electronic mail address extractor 37 and a destination electronic mail address rewriter 38, in addition to the user typestyle font selector 31, the electronic mail header-text separator 32, the character image data generator 33, the character image data encoder 34, the markup language text generator 35 and the electronic mail generator 36. Specifically, this electronic mail typestyle processing server 10 is characterized in that the text typestyle processor 27 thereof includes the electronic mail address extractor 37 and the destination electronic mail address rewriter 38. For other parts of the constitution thereof are similar to those of the electronic mail typestyle processing server 10 as previously described in the first embodiment or in the second embodiment. In this example, it is preferable that the user address allocated to each registered user inside the electronic mail typestyle processing server 10 is defined as the identifier of the registered user. In this way, if the user address allocated to each registered user is used as the identifier of the registered user, the registered user is not required to write down another identifier in the electronic mail for obtaining authorization by the electronic mail typestyle processing server 10.

The electronic mail address extractor 37 performs processing to extract the electronic mail address specified in the “Subject” in the header or in the text, that is, the electronic mail address of the receiver which is the actual destination, out of the electronic mail judged by the authorizer 25 as being subject to the typestyle processing service by the electronic mail typestyle processing server 10.

The destination electronic mail address rewriter 38 performs processing to rewrite the destination of the electronic mail (the “To” line in the header) from the user address inside the electronic mail typestyle processing server 10 which is allocated to the registered user to the electronic address of the receiver which is the actual destination extracted by the electronic mail address extractor 37.

In this electronic mail typestyle processing server 10, when the electronic mail transmitted from the transmission mail server 4 to the user address inside the electronic mail typestyle processing server 10 is received and the sender of this electronic mail is authorized as the registered user, the user typestyle font corresponding to the identifier of the registered user is selected by the user typestyle font selector 31 out of the user typestyle fonts stored in the font data memory 26, and simultaneously, the header portion and the text portion of the received electronic mail are separated by the electronic mail header-text separator 32. Moreover, the electronic mail address specified in the “Subject” in the header thereof or in the text thereof, that is, the electronic mail address of the receiver which is the actual destination, is extracted from the received electronic mail by the electronic mail address extractor 37.

The text portion of the electronic mail separated by the electronic mail header-text separator 32 is rasterized by the character image data generator 33 with the user typestyle font selected by the user typestyle font selector 31, whereby the character image data are generated. Moreover, the character image data in a binary format are replaced with an ASCII code format by the character image data encoder 34. Furthermore, HTML tags and the like are added to the character image data replaced with the ASCII code format by the markup language text generator 35.

In the meantime, the “To” line in the header portion of the electronic mail separated by the electronic mail header-text separator 32 is rewritten by the destination electronic mail address rewriter 38 from the user address inside the electronic mail typestyle processing server 10 which is allocated to the registered user to the electronic mail address of the receiver which is the actual destination extracted by the electronic mail address extractor 37.

Then, the header portion in which the “To” line (destination) is rewritten by the destination electronic mail address rewriter 38 is added to the HTML data constituting the electronic mail text by the electronic mail generator 36, whereby the electronic mail addressed to the receiver who is the actual destination is generated. Thereafter, this electronic mail will be transmitted to the receiving mail server 6 corresponding to the destination of this electronic mail via the Internet 2.

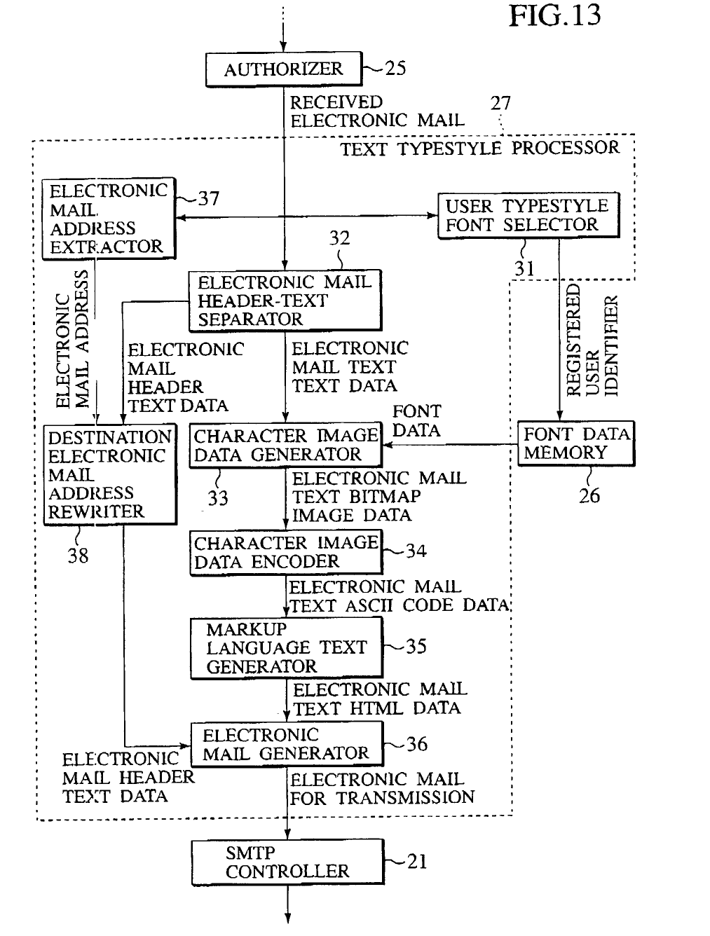

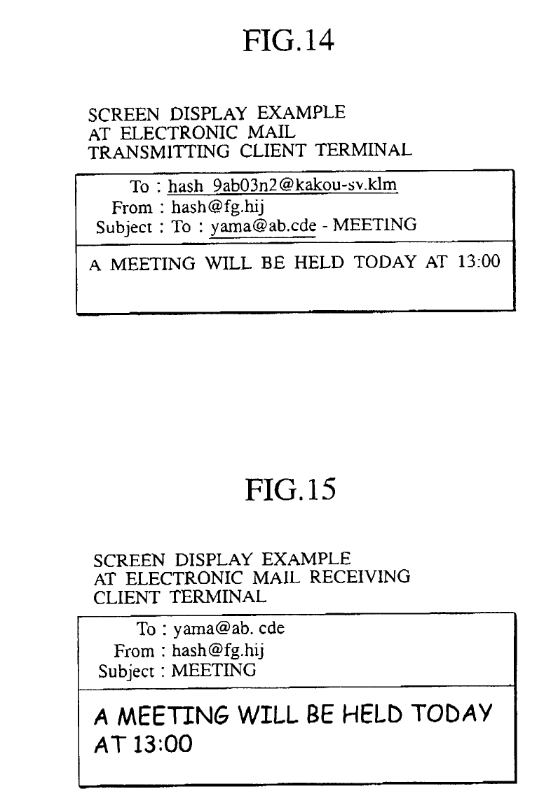

In this example, when the registered user creates the electronic mail, a screen as shown in FIG. 14, for example, will be displayed on the electronic mail transmission client terminal 3. On this screen as shown in FIG. 14, an upper part thereof illustrates the header of the electronic mail and a lower part thereof illustrates the text.

In this screen to be displayed on the electronic mail transmission client terminal 3, the user address of the sender (the registered user) inside the electronic mail typestyle processing server 10 will be specified in the “To” column, the electronic mail address of the sender (the registered user) will be specified in the “From” column, and the electronic mail address of the receiver which is the actual destination as well as the subject of the electronic mail will be specified in the “Subject” column. Meanwhile, the text indicating a message such as “A meeting will be held today at 13:00” will be written down in the text column in a normal style using a normal typestyle installed on the electronic mail transmission client terminal 3.

In the meantime, a screen as shown in FIG. 15, for example, will be displayed on the electronic mail receiving client terminal 5 which received the above-described electronic mail via the electronic mail typestyle processing server 10. On this screen as shown in FIG. 15, an upper part thereof illustrates the header of the electronic mail and a lower part thereof illustrates the text.

In this screen to be displayed on the electronic mail receiving client terminal 5, the electronic mail address of the receiver which is the actual destination will be specified in the “To” column, the electronic mail address of the sender will be specified in the “From” column, and the subject of the electronic mail will be specified in the “Subject” column. Meanwhile, the text indicating the message such as “A meeting will be held today at 13:00” will be displayed in the text column as the character image data in the typestyle reflecting the personality of the sender (the registered user) of the electronic mail.

In the case of performing transmission of the electronic mail by use of the electronic mail distribution system 1 of this example as described above, the sender of the electronic mail first registers himself as the user (the registered user) to receive the typestyle processing service by the electronic mail typestyle processing server 10 in order to obtain the user address inside the electronic mail typestyle processing server 10; specifically, “hash_{—}9ab03n2@kakou-sv.klm” as shown in the example illustrated in FIG. 14, for example. This user registration is required only once.

Then, when the registered user who registered himself as the user to receive the typestyle processing service by the electronic mail typestyle processing server 10 transmits the electronic mail, the registered user specifies his own user address inside the electronic mail typestyle processing server 10 in the “To” column in the header of the electronic mail for transmission, such as “hash_{—}9ab03n2@kakou-sv.klm”. Moreover, the registered user specifies the electronic mail address for the receiver which is the actual destination either into the “Subject” column in the header or into the text of the electronic mail for transmission in a predetermined format. In the example as shown in FIG. 14, the electronic mail address of the receiver which is the actual destination is specified as “To: yama@ab.cde” in the “Subject” column in the header of the electronic mail for transmission, for example.

The electronic mail thus created is sent from the transmission mail server 4 to the electronic mail typestyle processing server 10 according to the address specified in the “To” column in the header. Upon receipt of the electronic mail addressed to “hash_{—}9ab03n2@kakou-sv.klm”, the electronic mail typestyle processing server 10 recognizes the user address “hash_{—}9ab03n2@kakou-sv.klm” specified in the “To” column in the header as the identifier of the registered user, for example. Then, the electronic mail typestyle processing server 10 processes the typestyle of the text of this electronic mail by using the user typestyle font reflecting the personality of the registered user. Meanwhile, the electronic mail typestyle processing server 10 extracts the electronic mail address of the receiver “yama@ab.cde” specified in the “Subject” column or in the text, and then performs processing of rewriting the “To” column in the header from “hash_{—}9ab03n2@kakou-sv.klm” to “yama@ab.cde”. Thereafter, the electronic mail typestyle processing server 10 transmits the electronic mail to the receiving mail server 6, in which the typestyle of the text of the electronic mail is processed by use of the user typestyle font.

As described above, in the electronic mail distribution system 1 in this example, the user address inside the electronic mail typestyle processing server 10 is allocated to each registered user, then the electronic mail typestyle processing server 10 receives the electronic mail transmitted to this user address to process the typestyle of the text, and the electronic mail typestyle processing server 10 rewrites the destination of this electronic mail into the electronic mail address of the receiver which is the actual destination. Accordingly, while it is needless to say that terminals and mail servers used for general purposes are usable as the electronic mail transmission client terminal 3, the electronic mail receiving client terminal 5 and the receiving mail server 6, it is not necessary to install any special additional functions on the transmission mail server 4, and a generally-used mail server is also usable therefor.

Moreover, in this electronic mail distribution system 1, the user address of the registered user which the registered user specifies upon transmission of the electronic mail is rewritten into the electronic mail address of the receiver by the electronic mail typestyle processing server 10. Accordingly, the user address of the registered user is not disclosed to the receiver of the electronic mail. Therefore, even if this user address is used as the identifier of the registered user, for example, it is possible to prevent unauthorized use of the electronic mail typestyle processing server 10 by an unregistered user. When the user address is used as the identifier of the registered user, it is preferable to use an address which can be hardly inspired by a third person, such as “hash_{—}9ab03n2@kakou-sv.klm”, in order to prevent unauthorized use of the user typestyle font by another registered user registered with the electronic mail typestyle processing server 10.

(Fourth Embodiment)

Next, description will be made regarding a fourth embodiment adopting the present invention.

In the first to the third embodiments, the electronic mail of which the typestyle of the text is processed by the electronic mail typestyle processing server 10, that is, the electronic mail of which the text data of the text are replaced with the character image data using the user typestyle font, is transmitted to the electronic mail receiving client terminal 5 via the receiving mail server 6. However, in this fourth embodiment, the character image data of the text of the electronic mail created by the electronic mail typestyle processing server 10 using the user typestyle font are disclosed as a Web page, whereby the receiver of the electronic mail is allowed to browse the character image data of the electronic mail text created by use of the user typestyle font by means of having access to this Web page.

In this fourth embodiment, an electronic mail stating a URL for having access to the Web page where the character image data are disclosed will be transmitted to the receiver of the electronic mail. Then, the receiver of the electronic mail uses a Web browser normally installed on the electronic mail receiving client terminal 5 to have access to this Web page based on this URL, whereby the receiver browses the character image data of the electronic mail text.

In this fourth embodiment, the procedure of transmission of the electronic mail by the sender of the electronic mail is similar to the procedure as described in the third embodiment. Moreover, the electronic mail typestyle processing server 10 provides processing on the typestyle of the text of the received electronic mail by use of the user typestyle font, as similar to the electronic mail typestyle processing server 10 in the third embodiment.

The electronic mail typestyle processing server 10 according to the fourth embodiment is designed to save the character image data obtained by processing the typestyle of the text of the received electronic mail by use of the user typestyle font and to disclose the character image data in a Web page format. Moreover, this electronic mail typestyle processing server 10 is designed to exchange the text of the received electronic mail into the URL of the Web page where the character image data are disclosed, and to transmit the electronic mail in a text format stating the URL to the electronic mail receiving client terminal 5 via the receiving mail server 6. Note that disclosure of the web page may be carried out by the electronic mail typestyle processing server 10 itself, or the character image data may be transmitted to another Web server and disclosed by that Web server.

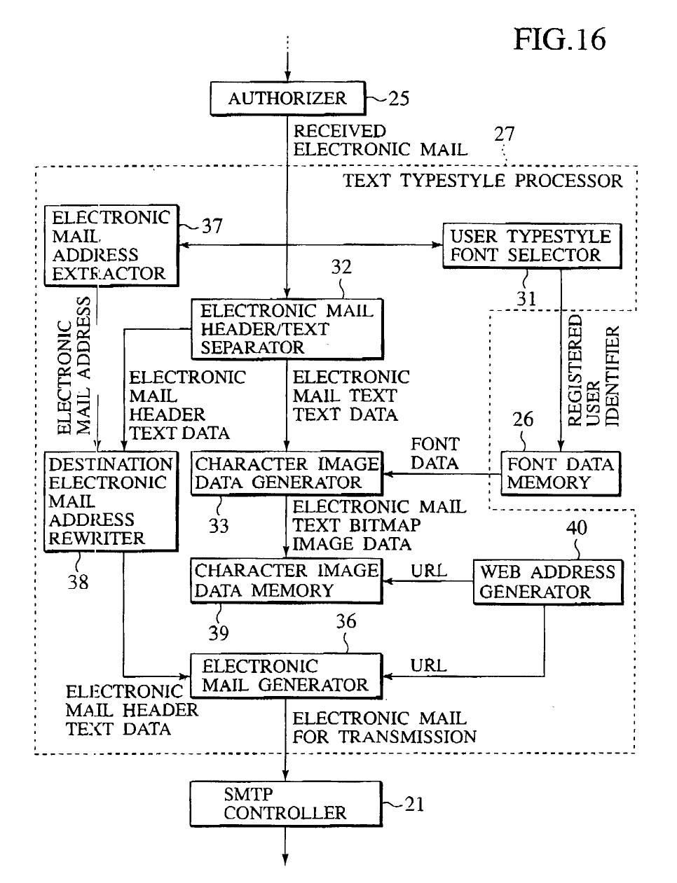

Here, description will be made in further detail regarding the electronic mail typestyle processing server 10 to be used in the foregoing electronic mail distribution system 1 with reference to FIG. 16. Note that FIG. 16 illustrates a functional block diagram of the text typestyle processor 27 in the electronic mail typestyle processing server 10.

In this electronic mail typestyle processing server 10, the text typestyle processor 27 thereof includes a character image data memory 39 and a Web address generator 40, in lieu of the character image data encoder 34 and the markup language text generator 35 included in the electronic mail typestyle processing server 10 of the third embodiment, whereby this electronic mail typestyle processing server 10 is characterized in that the electronic mail generator 36 thereof generates the electronic mail, in which the content of the text is exchanged for the URL of the Web page where the character image data are disclosed. For other parts of the constitution thereof are similar to those of the electronic mail typestyle processing server 10 of the third embodiment.

The character image data memory 39 saves the character image data such as bitmap data generated by the character image data generator 33, that is, the character image data obtained by rasterizing the text part of the electronic mail with the user typestyle font, and then the character image data memory 39 performs processing in order to disclose the character image data as a Web page.

The Web address generator 40 generates the URL of the Web page to disclose the character image data generated by the character image data generator 33.

The electronic mail generator 36 exchanges the text of the electronic mail separated by the electronic mail header-text separator 32 for the URL of the Web page generated by the Web address generator 40, that is, the URL of the Web page where the character image data generated by the character image data generator 33 are disclosed, thus generating the electronic mail to be transmitted to the receiver of the electronic mail.

In this electronic mail typestyle processing server 10, the electronic mail transmitted from the transmission mail server 4 to the user address inside the electronic mail typestyle processing server 10 is received. When the sender of this electronic mail is authorized as the registered user, the user typestyle font corresponding to the identifier of the registered user is selected by the user typestyle font selector 31 out of user typestyle fonts stored in the font data memory 26, and simultaneously, the header portion and the text portion are separated by the electronic mail header-text separator 32. Moreover, the electronic mail address specified in the “Subject” in the header or in the text thereof, that is, the electronic address of the receiver which is the actual destination, is extracted from the received electronic mail by the electronic mail address extractor 37.

The text portion of the electronic mail separated by the electronic mail header-text separator 32 is rasterized by the character image data generator 33 with the user typestyle font selected by the user typestyle font selector 31, thus generating the character image data. The character image data generated by this character image data generator 33 are saved in the character image data memory 39, and then the character image data are subjected to processing for disclosure as the Web page by this character image data memory 39.

Moreover, the URL of the Web page where the character image data are generated is generated by the Web address generator 40, and the text portion of the electronic mail separated by the electronic mail header-text separator 32 is exchanged for this URL of the Web page by the electronic mail generator 36.

Meanwhile, the “To” line in the header portion of the electronic mail separated by the electronic mail header-text separator 32 is rewritten by the destination electronic mail address rewriter 38 from the user address inside the electronic mail typestyle processing server 10 allocated to the registered user to the electronic mail address of the receiver which is the actual destination extracted by the electronic mail address extractor 37.

Thereafter, the header portion in which the “To” line (the destination) is rewritten by the destination electronic mail address rewriter 38 is added to the data constituting the electronic mail text, that is, the URL of the Web page where the character image data are disclosed, whereby the electronic mail addressed to the receiver who is the actual destination is generated. Then, this electronic mail will be transmitted to the receiving mail server 6 corresponding to the destination of this electronic mail via the Internet 2.

The receiver of the electronic mail receives the electronic mail, which is transmitted via the receiving mail server 6, with the electronic mail receiving client terminal 5. Then, the receiver confirms the URL written in the text thereof and has access to the Web page based on the URL, whereby the receiver can browse the character image data disclosed in this Web page, that is, the character image data in which the message from the sender is represented by the user typestyle font of the sender.

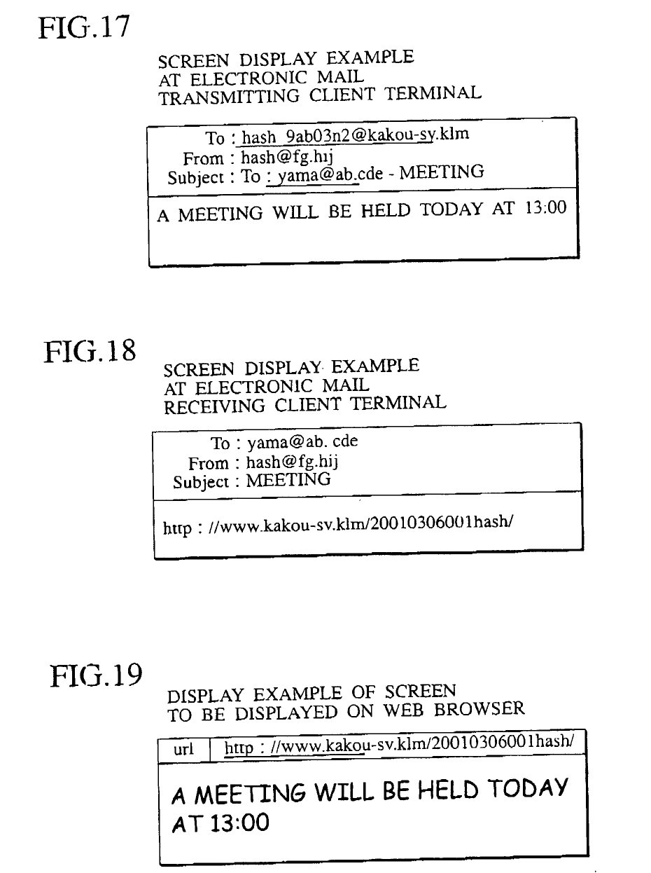

In this example, when the registered user creates the electronic mail, a screen as shown in FIG. 17, for example, will be displayed on the electronic mail transmission client terminal 3. In the screen shown in FIG. 17, an upper part thereof illustrates the header of the electronic mail and a lower part thereof illustrates the text.

In this screen to be displayed on the electronic mail transmission client terminal 3, the user address of the sender of the electronic mail (the registered user) inside the electronic mail typestyle processing server 10 will be specified in the “To” column, the electronic mail address of the sender of the electronic mail (the registered user) will be specified in the “From” column and the electronic mail address of the receiver which is the actual destination as well as the subject of the electronic mail will be specified in the “Subject” column. Moreover, text indicating a message such as “A meeting will be held today at 13:00” will be written down in the text column in a normal style using a normal typestyle installed on the electronic mail transmission client terminal 3.

In the meantime, a screen as shown in FIG. 18, for example, will be displayed on the electronic mail receiving client terminal 5 which received the above-described electronic mail via the electronic mail typestyle processing server 10. In the screen as shown in FIG. 18, an upper part thereof illustrates the header of the electronic mail and a lower part thereof illustrates the text.

In this screen to be displayed on the electronic mail receiving client terminal 5, the electronic mail address of the receiver which is the actual destination is specified in the “To” column, the electronic mail address of the sender is specified in the “From” column and the subject of the electronic mail is specified in the “Subject” column. In the meantime, the URL of the Web page, which discloses the character image data obtained by rasterizing the contents of the text by use of the user typestyle font, will be displayed in the text column.

Moreover, when the receiver has access to the Web page by use of the Web browser, then as shown in FIG. 19, the character image data disclosed in the Web page, that is, the character image data in which the message such as “A meeting will be held today at 13:00” is represented by the typestyle reflecting the personality of the sender of the electronic mail (the registered user), will be displayed thereon.

In the case of transmission the electronic mail by use of the electronic mail distribution system 1 of this example as described above, the sender of the electronic mail performs transmission of the electronic mail according to the procedure similar to that of the third embodiment.

The electronic mail typestyle processing server 10 recognizes the user address “hash_{—}9ab03n2@kakou-sv.klm” specified in the “To” column in the header of the received electronic mail, for example, as the identifier of the registered user. Then, the electronic mail typestyle processing server 10 processes the typestyle of the text of this electronic mail by use of the user typestyle font reflecting the personality of the registered user. Thereafter, the character image data generated by the processing are disclosed as the Web page at the URL such as “http://www.kakou-sv.klm/20010306001hash”, which is generated by the Web address generator.

Moreover, the electronic mail typestyle processing server 10 exchanges the data of the text of the received electronic mail for the URL obtained by the Web address generator, and simultaneously, extracts the electronic mail address “yama@ab.cde” of the receiver specified either in the “Subject” column in the header of the received electronic mail or in the text thereof. Then, the electronic mail typestyle processing server 10 performs processing to rewrite the “To” column in the header from “hash_{—}9ab03n2@kakou-sv.klm” to “yama@ab.cde”. Thereafter, the electronic mail typestyle processing server 10 transmits the electronic mail to the receiving mail server 6, in which the URL “http://www.kakou-sv.klm/20010306001hash” of the Web page where the character image data are disclosed is written down.

It should be noted that it is satisfactory if the URL of the Web page where the character image data are disclosed is made so as to effectuate unique specification of the character image data in which the text of the electronic mail is represented in the user typestyle font. Accordingly, the URL will be made as a combination of the date, a serial number and the user name, for example. Otherwise, a random URL may be also made in order to enhance confidentiality. Concerning disclosure of the Web page, user authorization with a password may take place in order to enhance confidentiality.

As it has been described above, in the electronic mail distribution system 1 of this example, the electronic mail typestyle processing server 10 is designed to rasterize the contents of the text of the electronic mail by use of the user typestyle font to generate the character image data. In addition, the electronic mail typestyle processing server 10 of this example is designed to disclose the character image data as the Web page, and to send the URL (in the text format) of the Web page to the electronic mail receiving client terminal 5. Therefore, it is satisfactory if the electronic mail receiving client terminal 5 just has a function of receiving an electronic mail in a simple text format. Accordingly, various terminals become usable as the electronic mail receiving client terminal 5. For example, regarding a mobile phone, there may be limitations from time to time that an attached file is deleted or volume for each electronic mail is restricted upon transmission of an electronic mail. However, in the electronic mail distribution system 1 of this example, such a mobile phone is also usable as the electronic mail receiving client terminal 5.

What is claimed is:

1. An electronic mail typestyle processing device mutually connected with an electronic mail transmission terminal and an electronic mail receiving terminal via information transmission means, said electronic mail typestyle processing device comprising:
a registered user identifier storing section for storing an identifier of a user registered in advance;
a user typestyle font storing section for storing a user typestyle font for each registered user, the user typestyle font reflecting personality of the registered user;
a receiving section for receiving an electronic mail transmitted from the electronic mail transmission terminal,
an authorizing section for referring to the registered user identifier storing section to judge as to whether data constituting the electronic mail received by the receiving section contains the identifier of the registered user; and
a typestyle processing section for creating character image data by processing a typestyle of text of the electronic mail judged by the authorizing section as containing the identifier of the registered user by use of the user typestyle font stored in the user typestyle font storing section.

2. The electronic mail typestyle processing device according to claim 1, wherein the registered user identifier storing section stores an electronic mail address of the registered user as the identifier of the registered user.

3. The electronic mail typestyle processing device according to any one of claims 1 and 2, further comprising:
a data replacing section for replacing the data constituting the text of the electronic mail judged by the authorizing section as containing the identifier of the registered user with the character image data created by the typestyle processing section; and
a transmitting section for transmitting the electronic mail, of which the data constituting the text are replaced with the character image data by the data replacing section, to the electronic mail receiving terminal.

4. The electronic mail typestyle processing device according to any one of claims 1 and 2, further comprising:
a character image data disclosing section for disclosing the character image data created by the typestyle processing section as a Web page;
an access information data replacing section for replacing the data constituting the text of the electronic mail, which is judged by the authorizing section as containing the identifier of the registered user, with access information for having use for access to the Web page; and
a transmitting section for transmitting the electronic mail, of which the data constituting the text are replaced with the access information by the access information data replacing section, to the electronic mail receiving terminal.

5. The electronic mail typestyle processing device according to any one of claims 1 to 4, further comprising:
a correspondence table storing section for storing an destination-based process propriety correspondence table in which an electronic mail address of each destination is recorded severally for the registered user in association with a specifier specifying as to whether the typestyle of the text of the electronic mail to be transmitted to each destination is to be processed; and
a process propriety discriminating section for referring to the destination-based process propriety correspondence table stored in the correspondence table storing section to judge for each destination as to whether the typestyle of the text of the electronic mail judged by the authorizing section as containing the identifier of the registered user is to be processed.

6. The electronic mail typestyle processing device according to any one of claims 1 to 5,
wherein an address inside the electronic mail typestyle processing device is allocated severally to the registered user and the receiving section is designed to receive an electronic mail transmitted to the address allocated severally to the registered user, and
the electronic mail typestyle processing device further includes:
an address extracting section for extracting an electronic mail address which is an actual destination out of the data constituting the electronic mail received by the receiving section: and
an address rewriting section for rewriting a destination address of the electronic mail received by the receiving section into the electronic mail address which is the actual destination.
